(19) United States
(12) Patent Application Publication
(10) Pub. No.: US 2003/0197790 A1
(43) Pub. Date: Oct. 23, 2003

(54) Device and method for displaying an image according to a peripheral luminous intensity

(76) Inventor: Seung-Gyun Bae, Kumi-shi (KR)

Correspondence Address: Peter L. Kendall, Roylance, Abrams, Berdo & Goodman, L.L.P., 1300 19th Street, N.W., Suite 600, Washington, DC, 20036, US

(21) Appl. No.: 10/419,930

(22) Filed: Apr. 22, 2003

(30) Foreign Application Priority Data
Apr. 22, 2002 (KR) 2002-22065

(51) Int. Cl. H04N 5/232

(52) U.S. Cl. 348/211.99

(57) ABSTRACT

A device and method for displaying an image signal received from a camera provided in a mobile communication terminal. If a sensitivity change is requested when the image signal received from the camera is displayed, a second sensitivity control signal for prolonging an integration time of the image signal of the camera is generated. Otherwise, a first sensitivity control signal is generated in a normal mode, and then the first sensitivity control signal is applied to the camera. In response to the sensitivity change request, the camera varies the integration time of the image signal, thereby obtaining a high-quality image signal.

### PRIORITY

This application claims priority to an application entitled “DEVICE AND METHOD FOR DISPLAYING IMAGE ACCORDING TO PERIPHERAL LUMINOUS INTENSITY”, filed in the Korean Industrial Property Office on Apr. 22, 2002 and assigned Serial No. 2002-22065, the contents of which are incorporated herein by reference.

### BACKGROUND OF THE INVENTION

1. Field of the Invention

The present invention relates to a device and method for displaying an image, and more particularly to a device and method capable of variably displaying an image according to a peripheral luminous intensity.

2. Description of the Related Art

Conventionally, a camera sensor contained in an image processing device can detect both infrared light and visible light. The camera sensor is a charge coupled device (CCD) image sensor or a complementary metal oxide semiconductor (CMOS) image sensor. Images captured by a camera can be displayed as moving images when 15 or more frames per second can be displayed. Thus, a display unit typically displays images corresponding to 15 or 30 frames per second.

Image data processed in the image processing device is displayed differently according to peripheral luminous intensities. That is, if a peripheral environment is dark, a boundary between an object and a background becomes unclear on a display image. At this time, colors also become dark on the display image. The above-described problems are raised because a period of time needed for integrating light in the camera is short and a light intensity is weak. Thus, when an image captured by the image processing device is displayed, there is a problem in that the image cannot be clearly displayed.

As small-sized camera devices have been developed, image capturing devices are currently being miniaturized. The current trend is to equip mobile communication terminals with camera devices. The mobile communication terminal can capture images, display moving and still pictures, and transmit the captured images. Because a major function of the mobile communication terminal is not to process the display image, the mobile communication terminal cannot provide a clearer display image than the typical image processing device. The mobile communication terminal is significantly affected by the peripheral environment when capturing and displaying the image.

### SUMMARY OF THE INVENTION

Therefore, the present invention has been made in view of the above problem, and it is an object of the present invention to provide a device and method capable of variably capturing and displaying an image according to luminous intensity.

It is another object of the present invention to provide a device and method capable of decrementing a frame rate when a peripheral environment is dark, and capturing and displaying an image.

It is yet another object of the present invention to provide a device and method capable of sensing a peripheral luminous intensity, and variably capturing and displaying an image according to the detected peripheral luminous intensity.

In accordance with one aspect of the present invention, the above and other objects can be accomplished by the provision of a device for displaying an image in a mobile communication terminal. The device comprises a keypad having keys for setting an image capture mode and a sensitivity change mode; a controller for generating an image capture control signal when the image capture mode key is inputted, and generating a corresponding sensitivity control command when the sensitivity change mode key is inputted; a camera for capturing an image signal; a signal processor, driven when the image capture control signal is generated, for processing the image signal outputted by the camera in a digital format, generating a sensitivity control signal having an image integration time longer than in a normal mode when the sensitivity control command is inputted, and applying the sensitivity control signal to the camera; an image processor for compressing and processing the image signal outputted by the signal processor when the image capture control signal is generated; and a display unit for displaying the processed image signal.

Another aspect of the present invention, provides a method for displaying an image in a mobile communication terminal with a camera. The method comprises displaying an image signal received from the camera in an image capture mode; and generating a second sensitivity control signal for prolonging an integration time of the image signal of the camera if a sensitivity change is requested in the image capture mode, generating a first sensitivity control signal in a normal mode if the sensitivity change is not requested, and applying the sensitivity control signal to the camera.

Still another aspect of the present invention, provides a method for displaying an image in a mobile communication terminal with a camera. The method comprises displaying an image signal received from the camera in an image capture mode; and generating a sensitivity control signal for prolonging an integration time of the image signal of the camera if the sensitivity change key is a sensitivity increment key and generating a sensitivity control signal for shortening an integration time of the image signal of the camera if the sensitivity change key is a sensitivity decrement key, when a sensitivity change key is inputted.

Still yet another aspect of the present invention, provides a method for displaying an image in a mobile communication terminal with a camera and a sensor for sensing a peripheral luminous intensity. The method comprises displaying an image signal received from the camera in an image capture mode; checking an output of the sensor in the image capture mode; and generating a second sensitivity control signal for prolonging an integration time of the image signal of the camera if the peripheral luminous intensity is smaller than a predetermined luminous intensity as a result of the checking, generating a first sensitivity control signal in a normal mode if the peripheral luminous intensity is not smaller than a predetermined luminous intensity as a result of the checking, and applying the sensitivity control signal to the camera.

Another aspect of the present invention, provides a method for displaying an image in a mobile communication terminal with a camera and a sensor for sensing a peripheral luminous intensity. The method comprises displaying an image signal received from the camera in an image capture mode; determining a kind of a sensitivity control mode in the image capture mode; generating a second sensitivity control signal for prolonging an integration time of the image signal of the camera if the sensitivity control mode is a manual mode as a result of the determination, generating a first sensitivity control signal in a normal mode if the sensitivity control mode is not the manual mode as a result of the determination, and applying the sensitivity control signal to the camera; and checking an output of the sensor if the sensitivity control mode is an automatic mode, generating the second sensitivity control signal for prolonging an integration time of the image signal of the camera if the peripheral luminous intensity is smaller than a predetermined luminous intensity as a result of the checking, generating the first sensitivity control signal in the normal mode if the peripheral luminous intensity is not smaller than a predetermined luminous intensity as a result of the checking, and applying the sensitivity control signal to the camera.

Another aspect of the present invention, provides a device for displaying an image in a mobile communication terminal. The method comprises a keypad having keys for setting an image capture mode and a sensitivity change mode; a sensor for sensing a peripheral luminous intensity; a controller for generating an image capture control signal when the image capture mode key is inputted, checking an output of the sensor in the image capture mode, generating a second sensitivity control command for prolonging an integration time of the image signal of the camera if the peripheral luminous intensity is smaller than a predetermined luminous intensity as a result of the checking, and generating a first sensitivity control command in a normal mode if the peripheral luminous intensity is not smaller than a predetermined luminous intensity as a result of the checking; a camera for capturing an image signal; a signal processor, driven when the image capture control signal is generated, for processing the image signal outputted by the camera in a digital manner, generating a sensitivity control signal having an image integration time longer than in the normal mode when the sensitivity control command is inputted, and applying the sensitivity control signal to the camera; an image processor, driven when the image capture control signal is generated, for compressing and processing the image signal outputted by the signal processor in units of frames; and a display unit for displaying the processed image signal.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating an example of components for an image processing device for variably displaying an image according to a peripheral luminous intensity in accordance with an embodiment of the present invention;

FIG. 2 is a block diagram illustrating an example of components for a signal processor shown in FIG. 1 in accordance with an embodiment of the present invention;

FIG. 3 is a flow chart illustrating an example of steps for displaying image data in accordance with an embodiment of the present invention;

FIG. 4 is a flow chart illustrating an example of steps for displaying image data in accordance with another embodiment of the present invention;

FIG. 5 is a flow chart illustrating an example of steps for displaying image data in accordance with another embodiment of the present invention; and

FIG. 6 is a flow chart illustrating an example of steps for displaying image data in accordance with another embodiment of the present invention.

### DETAILED DESCRIPTION OF THE PREFERRED EMBODIMENTS

Several embodiments of the present invention will be described in detail with reference to the accompanying drawings. In the drawings, the same or similar elements are denoted by the same reference numerals.

Those skilled in the art will appreciate that specific criteria such as a frame rate, the amplification of light, and so on at a time of capturing an image according to a peripheral luminous intensity are described only for illustrative purposes to help understand the present invention. It should be appreciated by those skilled in the art that the present invention can also be implemented without the specific criteria.

It is also noted that the term “image capture mode” refers to an operating mode for capturing an image signal through a camera and displaying the captured image signal. The term “sensitivity change mode” refers to an operating mode for changing an integration time of light according to a peripheral luminous intensity in the image capture mode. The term “first frame rate” refers to a frame rate of the image signal captured in a normal mode, and the term “second frame rate” refers to a frame rate of the image signal captured in the sensitivity change mode. The second frame rate is set to be smaller than the first frame rate. The term “preview” refers to an operation of displaying the image signal captured by the camera in the form of a moving picture. The term “still-picture capture mode” refers to an operating mode for capturing a still picture in a preview state.

It is assumed that a device for capturing and displaying an image according to a peripheral luminous intensity is a mobile communication terminal in accordance with embodiments of the present invention. However, the device and method in accordance with the embodiments of the present invention can be applied to any conventional image processing device for displaying an image using a camera other than the mobile communication terminal.

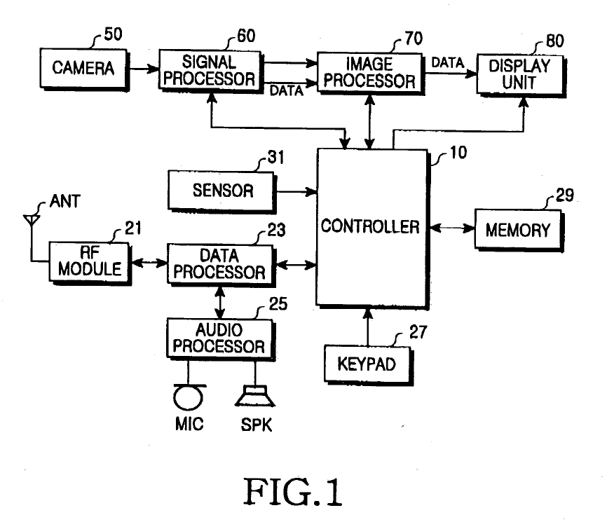

FIG. 1 is a block diagram illustrating an example of components for an image processing device for variably displaying an image according to a peripheral luminous intensity in accordance with the present invention, wherein the image processing device can be a mobile communication terminal.

Referring to FIG. 1, a radio frequency (RF) module 21 performs communications for the mobile communication terminal. The RF module 21 includes an RF transmitter (not shown) for up-converting and amplifying a frequency of a signal to be transmitted, an RF receiver (not shown) for carrying out a low noise amplification for a received signal and down-converting a frequency of the amplified received signal, and so on. A data processor 23 includes a transmitter (not shown) for encoding and modulating the transmission signal, a receiver (not shown) for demodulating and decoding the received signal, and so on. That is, the data processor 23 can be configured by a modem and a coder/decoder (codec). An audio processor 25 reproduces via the speaker (SPK) an audio signal received from the data processor 23 or transmits an audio signal from a microphone (MIC) to the data processor 23.

A keypad 27 includes keys for inputting numeric and character information and function keys for setting various functions. The keypad 27 further includes a mode setting key, an image capture key, etc. for capturing and displaying an image according to a peripheral luminous intensity in the embodiment of the present invention. A memory 29 comprises a program memory and a data memory. The program memory stores programs for controlling a general operation of the mobile communication terminal and programs for capturing and displaying the image according to the peripheral luminous intensity in accordance with an embodiment of the present invention. The data memory temporarily stores data generated while the programs are performed. A sensor 31 detects the peripheral luminous intensity and notifies a controller 10 of the detected luminous intensity.

The controller 10 controls the operation of the mobile communication terminal. In an embodiment of the present invention, the controller 10 can include the data processor 23. In accordance with another embodiment of the present invention, the controller 10 controls a signal processor 60 when an operating mode is changed through the keypad 27, and sets an image capture mode. Moreover, the controller 10 performs a control operation such that captured image data can be displayed according to the set image capture mode. In an automatic control mode, the controller 10 sets the image capture mode according to the peripheral luminous intensity detected by the sensor 31, and performs a control operation such that the captured image data can be displayed according to the set image capture mode.

A camera 50 captures an image and includes a camera sensor for converting a light signal of the captured image into an electric signal. In an embodiment of the present invention, the camera sensor can be a charge coupled device (CCD) image sensor. The signal processor 60 converts the image signal received from the camera 50 into digital image data. The signal processor 60 varies a frame rate of the image signal received from the camera 50 in response to a mode control signal received from the controller 10. In an embodiment of the present invention, the signal processor 60 can be implemented by a digital signal processor (DSP). An image processor 70 generates screen data for displaying the digital image data received from the signal processor 60. A display unit 80 displays the screen data generated by the image processor 70, and displays user data received from the controller 10.

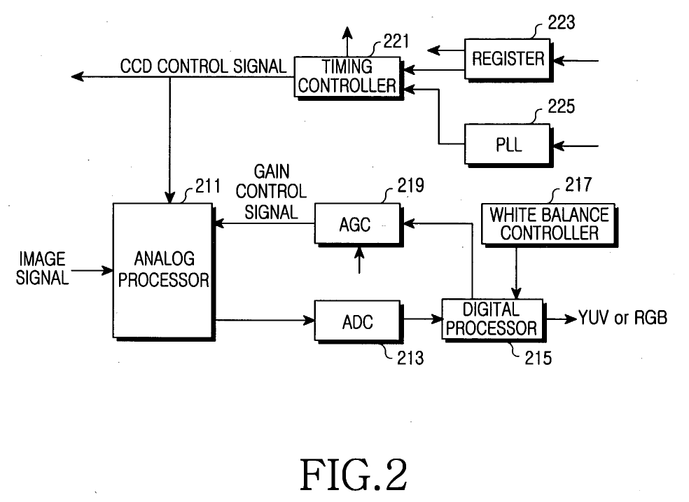

FIG. 2 is a block diagram illustrating an example of components for the signal processor 60 shown in FIG. 1 in accordance with an embodiment of the present invention.

Referring to FIG. 2, an analog processor 211 receives an analog image signal received from the sensor of the camera 50, and controls the amplification of the image signal in response to a gain control signal. An analog-to-digital converter (ADC) 213 converts the analog image signal received from the analog processor 211 into digital image data and then outputs the digital image data. In an embodiment of the present invention, the ADC 213 can be an 8-bit ADC. A digital processor 215 receives an output from the ADC 213, converts the digital image data into YUV or RGB data and outputs the YUV or RGB data. The digital processor 215 includes an internal line memory or frame memory, and outputs the processed image data in units of lines or frames. A white balance controller 217 controls a white balance of light. An automatic gain controller 219 generates the gain control signal for controlling a gain of the image signal in response to a mode control signal written to a register 223, and provides the generated gain control signal to the analog processor 211.

The register 223 stores control data received from the controller 10 to change a frame rate. The control data for changing the frame rate can be a first control data indicating a frame rate in a normal mode, a second control data indicating a frame rate in a dark mode having a luminous intensity smaller than the normal mode, a third control data indicating a frame rate in a bright mode having a luminous intensity larger than the normal mode, or etc. A phase-locked loop (PLL) circuit 225 provides a reference clock to control an operation of the signal processor 60. A timing controller 221 receives the reference clock from the PLL circuit 225, and generates a timing control signal to control the operation of the signal processor 60. Moreover, the timing controller 221 generates a frame control signal for setting a frame rate of a frame image signal received from the camera 50 in response to the control data received from the register 223.

An operation of setting the frame rate in accordance with an embodiment of the present invention will now be described in detail with reference to FIGS. 1 and 2.

First, an operation of the mobile communication terminal will be described. If a user performs a dialing operation through the keypad 27 when transmitting a call signal, and sets a communication mode, the controller 10 detects the set communication mode, processes dialing information received from the data processor 23, converts the dialing information into an RF signal through the RF module 21, and outputs the RF signal via the antenna (ANT). If a called party generates a response signal, the controller 10 detects the response signal from the called party through the RF module 21 and the data processor 23. A voice communication path is established through the audio processor 25, such that the user can communicate with the called party. In a call signal receiving mode, the controller 10 detects the call signal receiving mode through the data processor 23, and generates a ring signal through the audio processor 25. If the user gives a response to the ring signal, the controller 10 detects the response to the ring signal. Thus, the voice communication path is established through the audio processor 25, such that the user can communicate with the called party. Moreover, where the mobile communication terminal is in a standby mode or performs character communication, the controller 10 controls the display unit 80 such that the display unit 80 displays character data processed by the data processor 23.

The mobile communication terminal captures an image of a person or the peripheral environment, and displays or transmits the image. First, the camera 50 is mounted in the mobile communication terminal or connected to the mobile communication terminal at its predetermined external position. That is, the camera 50 can be an internal or external camera. The camera 50 can use a charge coupled device (CCD) image sensor. The image captured by the camera 50 is converted into an electric signal by an internal CCD image sensor, and the electric signal is applied to the signal processor 60. The signal processor 60 converts the image signal into digital image data, and outputs the digital image data to the image processor 70. The image processor 70 compresses and encodes the digital image data. The controller 10 can store the data outputted by the image processor 70 and externally transmit the data, if necessary. The image data outputted by the image processor 70 can be reproduced as a screen image through the display unit 80. In an embodiment of the present invention, the display unit 80 can be a liquid crystal display (LCD).

As described above, the mobile communication terminal can capture and display, or transmit an image of a person or the peripheral environment. At this time, the image capturing operation can be varied according to the peripheral environment. That is, if the luminous intensity is lowered or the peripheral environment is dark, an object or outline of the peripheral environment is not clearly displayed and a shape of the object is not clearly displayed. In this situation, if a period of time needed for integrating the light is prolonged, the resolution of the captured image can be enhanced. Moreover, if the amplification of light received from the sensor of the camera 50 is increased, the resolution of the image signal can be enhanced. The present invention provides at least two image capture modes according to peripheral luminous intensities. The present invention can vary a frame rate to enhance the resolution of the image captured in each image capture mode. When the frame rate is varied, the amplification of the image signal can be varied and hence the resolution of the image can be enhanced.

FIG. 2 is a view illustrating the configuration of the signal processor 60 shown in FIG. 1. The signal processor 60 can detect a peripheral luminous intensity according to a mode set by the user or an output of the sensor 31, and adjust an environment for capturing an image.

Referring to FIG. 2, first, the camera 50 includes a charge coupled device (CCD) image sensor, and converts a light signal of the captured image into an electric signal to output the electric signal. The analog processor 211 processes the image signal received from the camera 50. The analog processor 211 controls a gain of the image signal in response to a gain control signal, and varies a frame rate in response to a sensitivity control signal. Here, the sensitivity control signal can be a CCD control signal. An analog-to-digital converter (ADC) 213 converts the analog image signal received from the analog processor 211 into digital image data and then outputs the digital image data. A digital processor 215 includes a memory for storing the image data, converts the digital image data into RGB or YUV image data, and outputs the RGB or YUV image data. The memory storing the digital image data can be implemented by a line memory storing the image data in units of lines or a frame memory storing the image data in units of frames. It is assumed that the line memory is employed in accordance with an embodiment of the present invention. Moreover, it is assumed that the digital processor 215 converts the digital image data into the YUV image data in accordance with the embodiment of the present invention.

A white balance controller 217 generates a control signal for controlling a white balance of the image signal. The digital processor 215 adjusts a white balance of the processed image data. An automatic gain controller (AGC) 219 generates a signal for controlling a gain of the image signal and applies the gain control signal to the analog processor 211. A register 223 stores a mode control signal received from the controller 10. A phase-locked loop (PLL) circuit 225 generates a reference clock used in the signal processor 60. A timing controller 221 generates various control signals for the signal processor 60 in response to the reference clock received from the PLL circuit 225, and generates the CCD control signal to vary a frame rate of the image signal in response to the mode control signal applied from the register 223.

As described above, after the image signal outputted by the camera 50 is processed by the analog processor 211, the ADC 213 converts the analog image signal into digital data. The digital processor 215 converts the digital data into YUV data in units of lines, and applies the YUV data to the image processor 70. The CCD image sensor can detect not only visible light, but also infrared light. Although the integration time is short under conditions of high luminous intensity, as in the daytime, a high-quality image can be obtained. However, if the integration time is short under conditions of low luminous intensity as at night, a high quality image cannot be obtained. When integration time is short under conditions of low luminous intensity, an external illuminator such as a flash is preferably used so as to obtain a high quality image. However, it is difficult for the flash to be installed in a small-sized product such as the mobile communication terminal. In this case, if the integration time is prolonged, the high-quality image can be captured in a dark environment.

Accordingly, if a peripheral environment is dark in accordance with an embodiment of the present invention, the controller 10 generates a control signal for prolonging the integration time when the camera 50 captures the image and hence the timing controller 221 generates a CCD control signal. The camera 50 slightly varies a frame rate of the image signal in a normal mode that is, in the daytime or in a bright luminance state in response to the CCD control signal and then performs a capturing operation. Conventionally, if image data corresponding to 15 frames per second is generated, a moving picture can be appropriately obtained. Thus, when the peripheral environment is in a bright state corresponding to the normal mode, the CCD sensor is controlled such that image data corresponding to 15 frames or more per second can be generated. Moreover, when the peripheral environment is in a dark state e.g., at night, a dark room, etc., the CCD sensor is controlled such that image data corresponding to 5 frames per second can be generated. If so, the CCD sensor of the camera 50 can capture high-quality image data because the integration time can be prolonged. That is, if the image data corresponding to the 5 frames per second is generated, then its integration time can be three times longer than when generating the image data corresponding to the 15 frames per second. Thus, in this embodiment of the present invention, the frame rate of the captured image signal is varied according to the peripheral luminous intensity, and hence a high-quality image can be displayed. If the gain controller 219 controls a gain of an image signal, the higher-quality image can be displayed.

It is assumed that the mobile communication terminal is equipped with the camera 50.

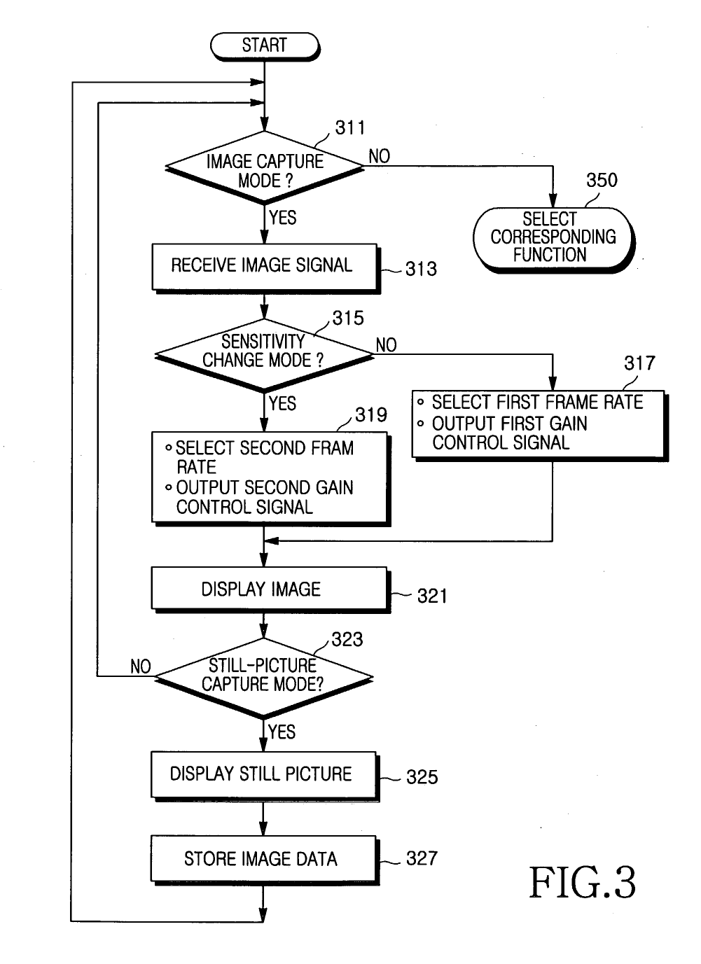

FIG. 3 is a flow chart illustrating an example of steps for displaying image data in accordance with an embodiment of the present invention.

Referring to FIG. 3, where a captured image is displayed on the display unit 80, the user generates key data for driving the camera 50 through the keypad 27. At this time, a key for operating an image capture mode can be arranged on a navigation key of the keypad 27. Alternatively, the key for driving the image capture mode can be displayed and selected as a menu item using a menu key. When the image capture mode is selected, the controller 10 detects the selected image capture mode at step 311. Then, the controller 10 activates a channel capable of receiving the captured image signal by controlling the signal processor 60 and the image processor 70, and receives the captured image signal from the camera 50 by controlling the signal processor 60 at step 313.

At step 350, if the image capture mode is not selected, the mobile terminal can perform a corresponding function, for example, be in a standby mode, establish a call and so on.

The controller 10 determines, at step 315, whether a sensitivity change mode has been set according to the luminous intensity of a peripheral environment at a time of capturing an image. Here, the sensitivity change mode can be set by the user through the keypad 27. A command needed for setting the sensitivity change mode can be implemented using a specified function key arranged on the keypad 27, or can be selected using the menu key. If the sensitivity change mode is set as described above, the controller 10 detects the set sensitivity change mode at step 315, and applies, to the signal processor 60, a sensitivity control command for setting a second frame rate to be used in the sensitivity change mode at step 319. Here, the sensitivity control command can be a control signal for setting the second frame rate. Alternatively, the sensitivity control command can be outputted as data for determining the number of frames needed for setting the second frame rate. That is, where 5 frames per second are displayed according to the second frame rate set in the sensitivity change mode, the control signal can be a signal indicating that the second frame rate has been set. In an embodiment of the present invention, the control signal can be data for setting the 5 frames per second as the second frame rate. The signal processor 60 generates a sensitivity control signal according to the second frame rate, outputs the sensitivity control signal to the camera 50, and supplies corresponding clocks inside the signal processor 60. On the other hand, if the sensitivity change mode is not set at the above step 315, that is, the normal mode is set, the controller 10 proceeds to step 317, and applies the control signal or data for selecting the first frame rate to the signal processor 60. Then, the signal processor 60 generates the sensitivity control signal according to the first frame rate, outputs the sensitivity control signal to the camera 50, and supplies corresponding clocks inside the signal processor 60. Further, the signal processor 60 controls the gain controller 219 according to the sensitivity control signal, generates a gain control signal in a corresponding mode and varies the amplification of light. The second gain control signal generated in the sensitivity change mode has a higher amplification than the first gain control signal generated in the normal mode.

It is assumed that there is a single sensitivity change mode in FIG. 3. However, at least two sensitivity change modes can be set and used.

After performing the above step 319 or 317, the controller 10 controls the signal processor 60 and the image processor 70 such that the image signal captured by the camera 50 can be displayed. At this time, the displayed image signal corresponds to a preview screen as a moving picture. Where the image signal of the 15 frames per second is displayed on the preview screen in the normal mode, an appropriate moving picture is displayed. However, where the image signal of the 5 frames per second in the sensitivity change mode is displayed, the quality of the image screen in the sensitivity change mode is not better than that of the moving picture screen in the normal mode. At this time, if the integration time of light is prolonged, a high-quality screen image can be displayed.

The user can identify the displayed moving picture and generate a still-picture capture command to obtain a still picture at a specified time, in a state that a preview image is displayed at step 321. The still-picture capture command can be generated using a specified function key arranged on the keypad 27 or selected using a menu key. If the still-picture capture command is generated, the controller 10 detects the generated still-picture capture command at step 323, and captures a still picture from currently displayed image pictures by controlling the image processor 70 at step 325. At step 327, the controller 10 reads image data of the still picture, stores the read image data in an image memory area contained in the memory 29, and returns to the above step 311.

As described above, if the user sets the sensitivity change mode in a state that a moving picture is displayed in accordance with the first embodiment of the present invention, there is set a frame rate of the sensitivity change mode lower than a frame rate of the normal mode. The amplification of an image signal is changed according to the frame rate. When an image is captured at night or indoors, the integration time in the sensitivity change mode is maintained longer than that in the normal mode such that a high-quality image signal can be captured.

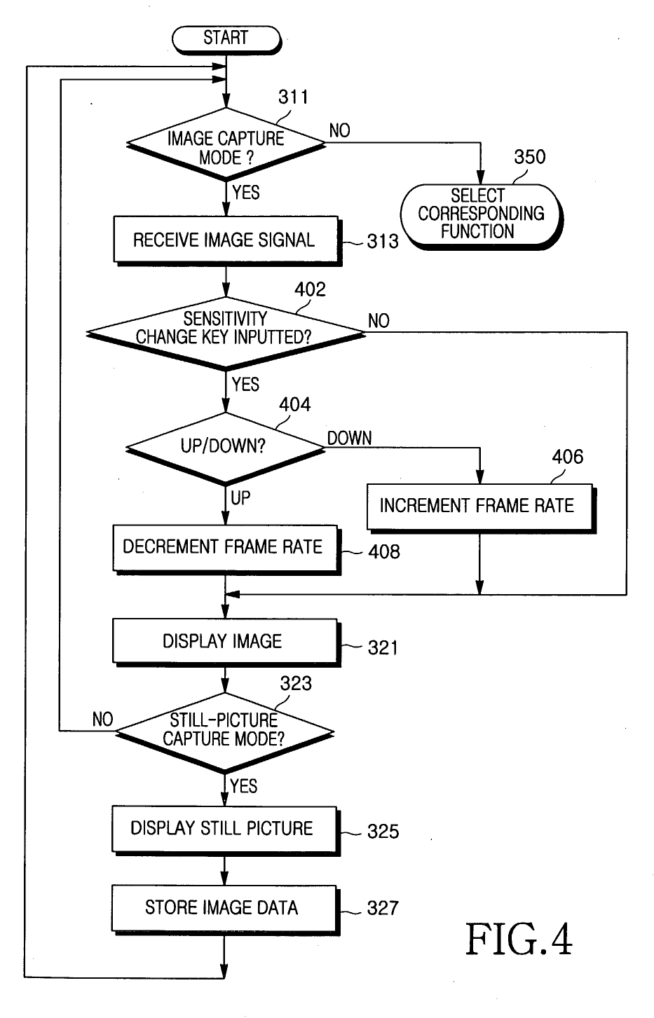

FIG. 4 is a flow chart illustrating an example of steps for displaying image data in accordance with another embodiment of the present invention. In accordance with a second embodiment of the invention, there is disclosed a method for more precisely controlling a frame rate using sensitivity change keys in place of setting the sensitivity change mode.

Referring to FIG. 4, an image signal is received from the camera 50 while the above steps 311 and 313 are performed.

In the second embodiment, the sensitivity change keys are arranged on the keypad 27. The user requests a sensitivity change using the sensitivity change keys in the preview state. The sensitivity change keys can be implemented by up/down keys of the navigation keys. At step 402, the controller 10 detects an input of the up or down key for changing the sensitivity if the up or down key is inputted. At step 404 a decision is made whether to change the sensitivity up or down. If the up key is inputted, the controller 10 decrements a frame rate at step 408. On the other hand, if the down key is inputted, the controller 10 increments a frame rate at step 406. The signal processor 60 controls the gain controller 219 according to the sensitivity control data, generates a gain control signal corresponding to the changed frame rate, and varies the amplification of light. In this case, the amplification of light corresponding to the gain control signal generated in a dark environment is higher than that corresponding to a gain control signal generated in a bright environment.

It is assumed that a sensitivity changing range is set to the maximum number of 15 frames per second, and one frame is incremented or decremented every time a sensitivity change key is inputted. Thus, the controller 10 determines a kind of the sensitivity change key via the up or down key or the number of key inputs in a unit of a predetermined time. At the above steps 406 and 408, the controller 10 generates sensitivity control data corresponding to frame rate change data based on a result of the determination, and outputs the generated sensitivity control data to the signal processor 60. The sensitivity control data can be information containing a flag indicating the increment or decrement of the frame rate and the number of frames. The signal processor 60 generates a sensitivity control signal based on the sensitivity control data and then outputs the sensitivity control signal to the camera 50. Thus, the signal processor 60 generates clocks to be used inside the signal processor 60.

As described above, the controller 10 performs the above steps 321 to 327 to display the image, and then proceeds to the above step 311.

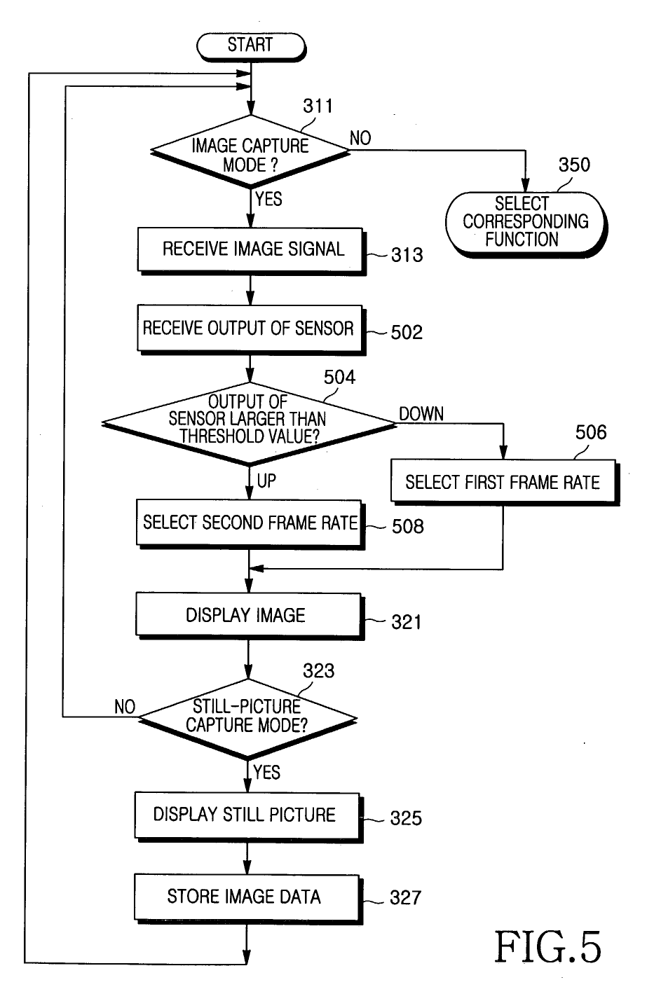

FIG. 5 is a flow chart illustrating an example of steps for displaying image data in accordance with another embodiment of the present invention. In a third embodiment of the present invention, a sensor 31 is provided to detect the luminous intensity of a peripheral environment. There is disclosed a method for varying a frame rate by automatically operating a sensitivity change mode according to a luminous intensity sensing signal.

Referring to FIG. 5, an image signal is received from the camera 50 while the above steps 311 and 313 are performed.

In the third embodiment, the controller 10 has at least one threshold value for analyzing a signal detected by the sensor 31. That is, the controller 10 compares an output of the sensor 31 with the threshold value and then determines whether the output of the sensor 31 indicates a mode for changing the sensitivity or not. When there are two threshold values, at least two sensitivity change modes are provided. Frame rates can be set according to the sensitivity change modes. It is assumed that a single sensitivity change mode is used in accordance with an embodiment of the present invention.

In the preview state, the controller 10 receives the output of the sensor 31 at step 502. Then, at step 504, the controller 10 compares the output of the sensor 31 with a predetermined threshold value and then determines whether the output of the sensor 31 indicates a sensitivity change mode. Here, it is assumed that the sensitivity change mode is set when the output of the sensor 31 is smaller than the threshold value. At the above step 504, the controller 10 sets the sensitivity change mode if the output of the sensor 31 is smaller than the threshold value. At step 508, the controller 10 applies, to the signal processor 60, a sensitivity control command for setting a second frame rate to be used in the sensitivity change mode. Then, the signal processor 60 generates a sensitivity control signal based on the second frame rate, outputs the generated sensitivity control signal to the camera 50, and supplies corresponding clocks inside the signal processor 60. On the other hand, the controller 10 applies, to the signal processor 60, a control signal or data for selecting a first frame rate at step 506, if the output of the sensor 31 is larger than the threshold value at step 504, that is, if the output of the sensor 31 corresponds to the normal mode. The signal processor 60 generates a sensitivity control signal based on the second frame rate, outputs the generated sensitivity control signal to the camera 50, and supplies corresponding clocks inside the signal processor 60. The signal processor 60 controls the gain controller 219 according to the sensitivity control signal, generates a gain control signal in a corresponding mode, and varies the amplification of light. In this case, the amplification of light corresponding to a second gain control signal in the sensitivity change mode is higher than that corresponding to a first gain control signal in the normal mode.

As described above, the controller 10 performs the above steps 321 to 327 to display an image signal and proceeds to the above step 311.

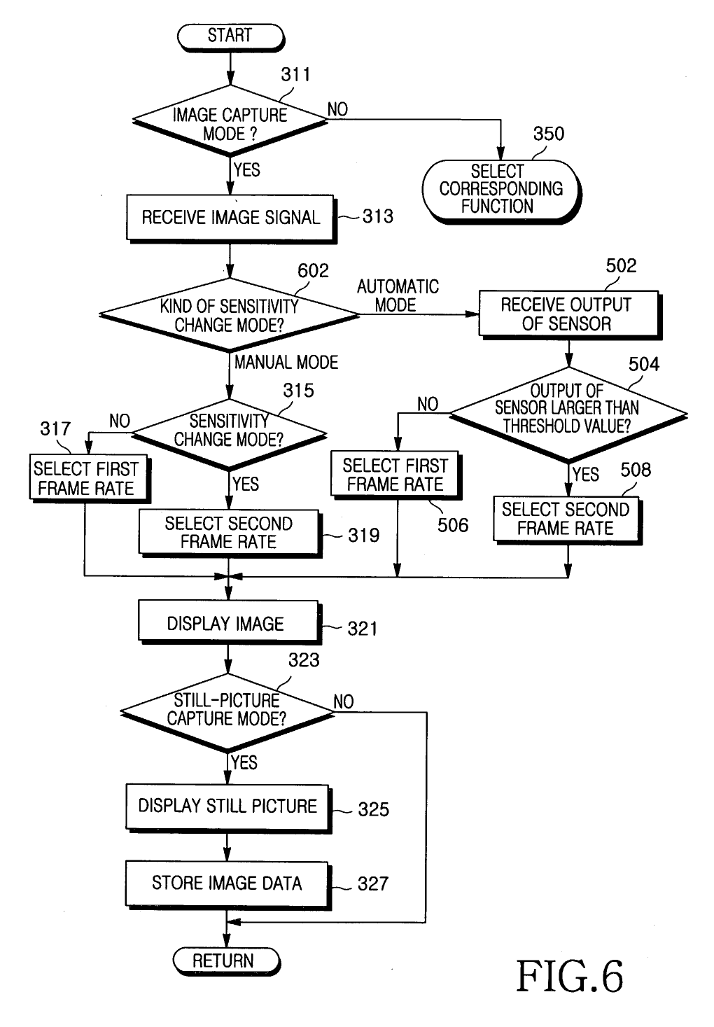

FIG. 6 is a flow chart illustrating an example of steps for displaying image data in accordance with another embodiment of the present invention. In a fourth embodiment of the present invention, the sensor 31 is provided to detect the luminous intensity of a peripheral environment. There is disclosed a method for varying a frame rate in a manual mode for operating a sensitivity change mode set by the user and an automatic mode for operating a sensitivity change mode according to a luminous intensity sensing signal received from the sensor 31.

Referring to FIG. 6, an image signal is received from the camera 50 while steps 311 to 313 are performed.

To perform the fourth embodiment, specified function keys for selecting the manual or automatic mode are arranged on the keypad 27. In an embodiment of the present invention, the manual or automatic mode can be selected using a menu. The user selects the manual or automatic mode using the specified function keys or the menu when the preview screen is displayed. The controller 10 determines a kind of the sensitivity change mode at step 602. If the sensitivity change mode corresponds to the manual mode, an operation shown in FIG. 3 is performed. On the other hand, if the sensitivity change mode corresponds to the automatic mode, an operation shown in FIG. 5 is performed.

As described above, an image processing device with a camera can vary a period of time for accumulating an image signal according to a peripheral luminous intensity when capturing the image signal, thereby providing a high-quality image irrespective of the peripheral luminous intensity. That is, the image processing device can vary a frame rate and/or a gain control signal when the image is captured in a dark environment and change the integration time of light and/or the amplification of light, thereby providing a high-quality image.

Although several embodiments of the present invention have been disclosed for illustrative purposes, those skilled in the art will appreciate that various modifications, additions and substitutions are possible, without departing from the scope of the invention. Accordingly, the present invention is not limited to the above-described embodiments, but the present invention is defined by the claims which follow, along with their full scope of equivalents.

What is claimed is:

1. A device for displaying an image in a mobile communication terminal, comprising:
a keypad having keys for setting an image capture mode and a sensitivity change mode;
a controller for generating an image capture control signal when the image capture mode key is inputted, and generating a corresponding sensitivity control command when the sensitivity change mode key is inputted;
a camera for capturing an image signal;
a signal processor, driven when the image capture control signal is generated, for processing the image signal outputted by the camera in a digital format, generating a sensitivity control signal having an image integration time longer than in a normal mode when the sensitivity control command is inputted, and applying the sensitivity control signal to the camera;
an image processor for compressing and processing the image signal outputted by the signal processor when the image capture control signal is generated; and
a display unit for displaying the processed image signal.

2. The device as set forth in claim 1, wherein the signal processor generates the sensitivity control signal having a frame rate lower than a frame rate in the normal mode when the sensitivity control command is received, and then applies the sensitivity control signal to the camera.

3. The device as set forth in claim 2, wherein the frame rate in the normal mode comprises 15 frames per second, and the frame rate in the sensitivity change mode comprises 5 frames per second.

4. A method for displaying an image in a mobile communication terminal with a camera, comprising the steps of:
displaying an image signal received from the camera in an image capture mode; and
generating a second sensitivity control signal for prolonging an integration time of the image signal of the camera if a sensitivity change is requested in the image capture mode, generating a first sensitivity control signal in a normal mode if the sensitivity change is not requested, and applying the sensitivity control signal to the camera.

5. The method as set forth in claim 4, wherein the sensitivity control signal controls a frame rate of the image signal captured by the camera, and a frame rate of the second sensitivity control signal is lower than that of the first sensitivity control signal.

6. The method as set forth in claim 5, wherein the first sensitivity control signal corresponds to 15 frames per second, and the second sensitivity control signal corresponds to 5 frames per second.

7. The method as set forth in claim 4, further comprising the step of:
varying amplification of the image signal when the sensitivity control signal is generated, and setting amplification of the second sensitivity control signal higher than amplification of the first sensitivity control signal when the second sensitivity control signal is generated.

8. A method for displaying an image in a mobile communication terminal with a camera, comprising the steps of:
displaying an image signal received from the camera in an image capture mode; and
generating a sensitivity control signal for prolonging an integration time of the image signal of the camera if the sensitivity change key is a sensitivity increment key and generating a sensitivity control signal for shortening an integration time of the image signal of the camera if the sensitivity change key is a sensitivity decrement key, when a sensitivity change key is inputted.

9. The method as set forth in claim 8, further comprising the step of:
controlling a sensitivity increment and the integration time in a unit of the predetermined number of frames per second on the basis of sensitivity.

10. A method for displaying an image in a mobile communication terminal with a camera and a sensor for sensing a peripheral luminous intensity, comprising the steps of:
displaying an image signal received from the camera in an image capture mode;
checking an output of the sensor in the image capture mode; and
generating a second sensitivity control signal for prolonging an integration time of the image signal of the camera if the peripheral luminous intensity is smaller than a predetermined luminous intensity as a result of the checking, generating a first sensitivity control signal in a normal mode if the peripheral luminous intensity is not smaller than a predetermined luminous intensity as a result of the checking, and applying the sensitivity control signal to the camera.

11. A method for displaying an image in a mobile communication terminal with a camera and a sensor for sensing a peripheral luminous intensity, comprising the steps of:
displaying an image signal received from the camera in an image capture mode;
determining a kind of a sensitivity control mode in the image capture mode;
generating a second sensitivity control signal for prolonging an integration time of the image signal of the camera if the sensitivity control mode is a manual mode as a result of the determination, generating a first sensitivity control signal in a normal mode if the sensitivity control mode is not the manual mode as a result of the determination, and applying the sensitivity control signal to the camera; and
checking an output of the sensor if the sensitivity control mode is an automatic mode, generating the second sensitivity control signal for prolonging an integration time of the image signal of the camera if the peripheral luminous intensity is smaller than a predetermined luminous intensity as a result of the checking, generating the first sensitivity control signal in the normal mode if the peripheral luminous intensity is not smaller than a predetermined luminous intensity as a result of the checking, and applying the sensitivity control signal to the camera.

12. A device for displaying an image in a mobile communication terminal, comprising:
a keypad having keys for setting an image capture mode and a sensitivity change mode;
a sensor for sensing a peripheral luminous intensity;
a controller for generating an image capture control signal when the image capture mode key is inputted, checking an output of the sensor in the image capture mode, generating a second sensitivity control command for prolonging an integration time of the image signal of the camera if the peripheral luminous intensity is smaller than a predetermined luminous intensity as a result of the checking, and generating a first sensitivity control command in a normal mode if the peripheral luminous intensity is not smaller than a predetermined luminous intensity as a result of the checking;
a camera for capturing an image signal;
a signal processor for processing the image signal outputted by the camera in a digital manner, generating a sensitivity control signal having an image integration time longer than in the normal mode when the sensitivity control command is inputted, and applying the sensitivity control signal to the camera to drive the signal processor when the image capture control signal is generated,;
an image processor for compressing and processing the image signal outputted by the signal processor in units of frames to drive the image processor when the image capture control signal is generated,; and
a display unit for displaying the processed image signal.
